(19) United States
(12) Patent Application Publication
(10) Pub. No.: US 2014/0167525 A1
(43) Pub. Date: Jun. 19, 2014

(54) TECHNIQUES FOR EFFICIENT POWER TRANSFERS IN A CAPACITIVE WIRELESS POWERING SYSTEM

(71) Applicants: Dave Willem Van Goor, Nederweert (NL); Adrianus Sempel, Waalre (NL); Eberhard Waffenschmidt, Aachen (DE); Henricus Theodorus Van Der Zanden, Sint-Oedenrode (NL)

(72) Inventors: Dave Willem Van Goor, Nederweert (NL); Adrianus Sempel, Waalre (NL); Eberhard Waffenschmidt, Aachen (DE); Henricus Theodorus Van Der Zanden, Sint-Oedenrode (NL)

(73) Assignee: KONINKLIJKE PHILIPS N.V., EINDHOVEN (NL)

(21) Appl. No.: 14/237,458

(22) PCT Filed: Aug. 2, 2012
(86) PCT No.: PCT/IB2012/053960

§ 371 Date: Feb. 6, 2014

Related U.S. Application Data
(60) Provisional application No. 61/523,928, filed on Aug. 16, 2011.
(60) Provisional application No. 61/622,102, filed on Apr. 10, 2012.

(51) Int. Cl. H01F 38/14

(52) U.S. Cl. CPC H01F 38/14
USPC 307/104

(57) ABSTRACT

A capacitive powering system (100) comprises a low power driver (111), a high power driver (112), a plurality of pairs of transmitter electrodes separated into a plurality of power sub-areas (210-1, 210-N) including at least a group of high power sub-areas (210-1, 210-M) connected to the high power driver and a group of low power sub-areas (210-M+1, 210-N) connected to the low power driver, and an insulating layer (130) having a first side and a second side opposite to each other, the pairs of plurality of transmitter electrodes are coupled to the first side of the insulating layer. The system is configured to form a capacitive impedance between the pairs of plurality of transmitter electrodes and a plurality of pairs of receiver electrodes (141, 144) placed in proximity to the second side of the insulating layer to wirelessly power each load connected to each of the pair of receiver electrodes.

This application claims priority from U.S. provisional application No. 61/523,928 and U.S. provisional application No. 61/523,929, both filed on Aug. 16, 2012 and U.S. provisional application No. 61/622,102 filed on Apr. 10, 2012.

The invention generally relates to capacitive powering systems for wireless power transfers, and more particularly to structures for allowing efficient power transfers in a large area wireless powering system including hot spots.

A wireless power transfer refers to the supply of electrical power without any wires or contacts, thus the powering of electronic devices is performed through a wireless medium. One popular application for contactless powering is for the charging of portable electronic devices, e.g., mobiles phones, laptop computers, and the like.

One implementation for wireless power transfers is by an inductive powering system. In such a system, the electromagnetic inductance between a power source (transmitter) and the device (receiver) allows for contactless power transfers. Both the transmitter and receiver are fitted with electrical coils, and when brought into physical proximity, an electrical signal flows from the transmitter to the receiver.

In inductive powering systems, the generated magnetic field is concentrated within the coils. As a result, the power transfer to the receiver pick-up field is very concentrated in space. This phenomenon creates hot-spots in the system which limits the efficiency of the system. To improve the efficiency of the power transfer, a high quality factor for each coil is needed. To this end, the coil should be characterized with an optimal ratio of an inductance to resistance, be composed of materials with low resistance, and be fabricated using a Litze-wire process to reduce skin-effect. Moreover, the coils should be designed to meet complicated geometries to avoid Eddy-currents. Therefore, expensive coils are required for efficient inductive powering systems. A design for a contactless power transfer system for large areas would necessitate many expensive coils, thus for such applications an inductive powering system may not be feasible.

Capacitive coupling is another technique for transferring power wirelessly. This technique is predominantly utilized in data transfer and sensing applications. A car-radio antenna glued on the car's window, with a pick-up element inside the car, is one example of a capacitive coupling system. The capacitive coupling technique is also utilized for contactless charging of electronic devices. For such applications, the charging unit (implementing the capacitive coupling) operates at frequencies outside the inherent resonance frequency of the device.

A capacitive power transfer system can also be utilized to transfer power over large areas, e.g., windows, walls, and so on. For example, such a system can be utilized to power lighting fixtures installed on wall. An arrangement of such a system typically includes a pair of receiver electrodes connected to a load and inductor, a pair of transmitter electrodes connected to a driver, and an insulating layer. The transmitter electrodes are coupled to one side of the insulating layer and the receiver electrodes are coupled from the other side of the insulating layer. This arrangement forms capacitive impedance between the pair of transmitter electrodes and the receiver electrodes. Therefore, a power signal generated by the power driver can be wirelessly transferred from the transmitter electrodes to the receiver electrodes to power the load when a frequency of the power signal matches a series-resonance frequency of the system. The load may be, for example, a LED, a LED string, a lamp, and the like.

Because capacitive power transfer is designed to transfer over a large area, the load should stay powered and operational when it is moved across the infrastructure of the system. However, the infrastructure may also include hot spots and areas where “wireless coverage” is not provided, i.e., power cannot be wirelessly transferred from the transmitter to the receiver electrodes. A hot spot is an area in the infrastructure where a relatively high power exists. Typically, such areas are created when high power driver powers the capacitive system.

Hot spots in a capacitive wireless system where multiple loads are connected may downgrade the performance of the system. Specifically, in a capacitive power transfer system that includes multiple loads, the power consumed by the different loads may be different from each other. Each load is connected to a different pair of the receiver electrodes. In a capacitive power transfer system the load that consumes the highest power typically determines the requirements for AC signal power and the conductive materials. When a “high power load” (e.g., a 10 W lamp) and a “low power load” (e.g., a 0.1 W LED indicator) are connected in the system, the AC signal would damage the low power load. In addition, the system cannot be optimized to support both loads, as each load has different driver power properties. Further, the conductive material and dimensions of the transmitter electrodes cannot be optimized to support the respective loads.

Therefore, it would be advantageous to provide a solution for efficient power transfers in a large area wireless power system that includes power hot spots.

Certain embodiments disclosed herein include a capacitive powering system. The system includes a low power driver (111); a high power driver (112); a plurality of pairs of transmitter electrodes separated into a plurality of power sub-areas (210-1, 210-N), wherein the plurality of power sub-areas include at least a group of high power sub-areas (210-1, 210-M) connected to the high power driver and a group of low power sub-areas (210-M+1, 210-N) connected to the low power driver; and an insulating layer (130) having a first side and a second side opposite to each other, wherein the pairs of plurality of transmitter electrodes are coupled to the first side of the insulating layer, wherein the system is configured to form a capacitive impedance between the pairs of plurality of transmitter electrodes and a plurality of pairs of receiver electrodes (141, 144) placed in proximity to the second side of the insulating layer, each pair of receiver electrodes is connected to a load through an inductor to resonate at a different series-resonance frequency, thereby wirelessly transferring power from a pair of transmitter electrodes to a respective pair of receiver electrodes to power the load connected to the pair of receiver electrodes.

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

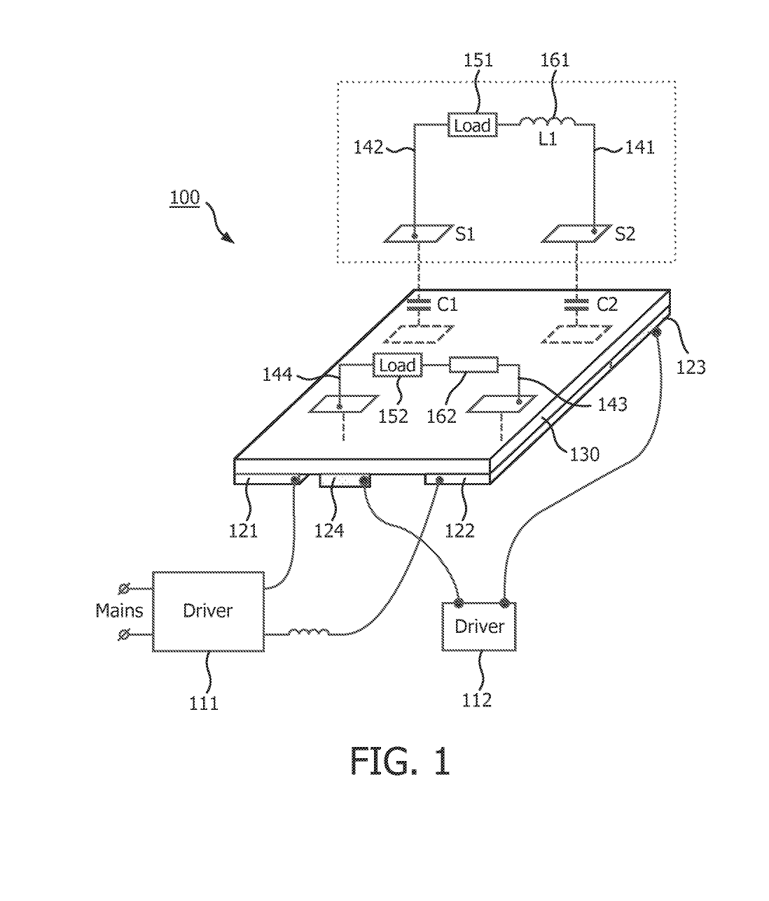

FIG. 1 is a capacitive power system utilized for describing various embodiments of the system.

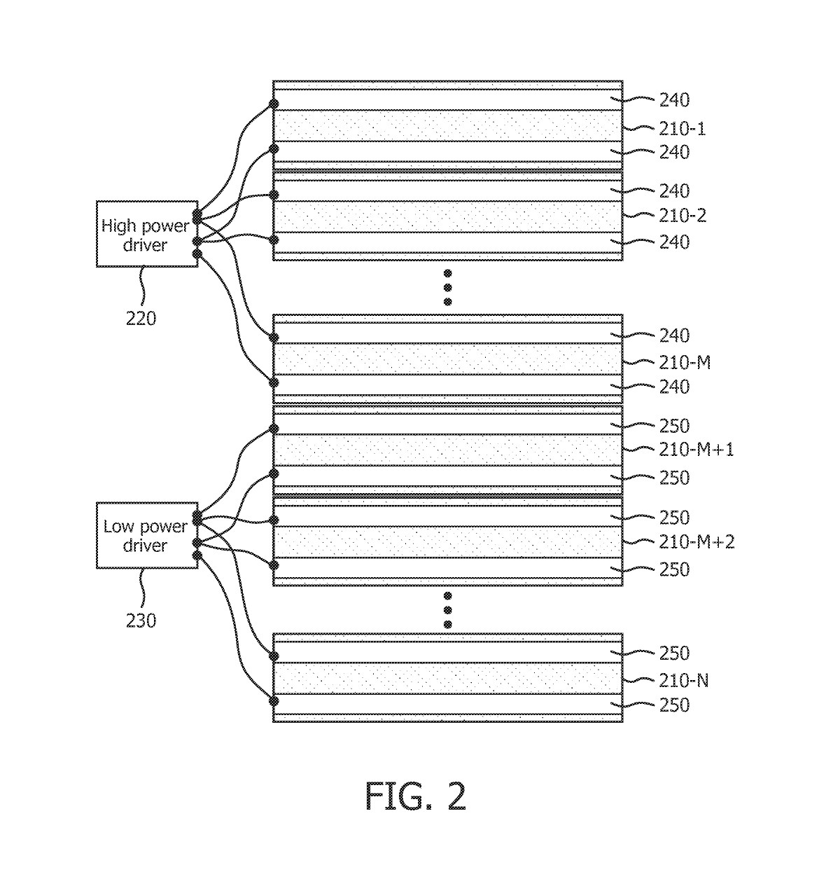

FIG. 2 is an illustration of an arrangement of power sub-areas in a capacitive powering system according to an embodiment of the invention.

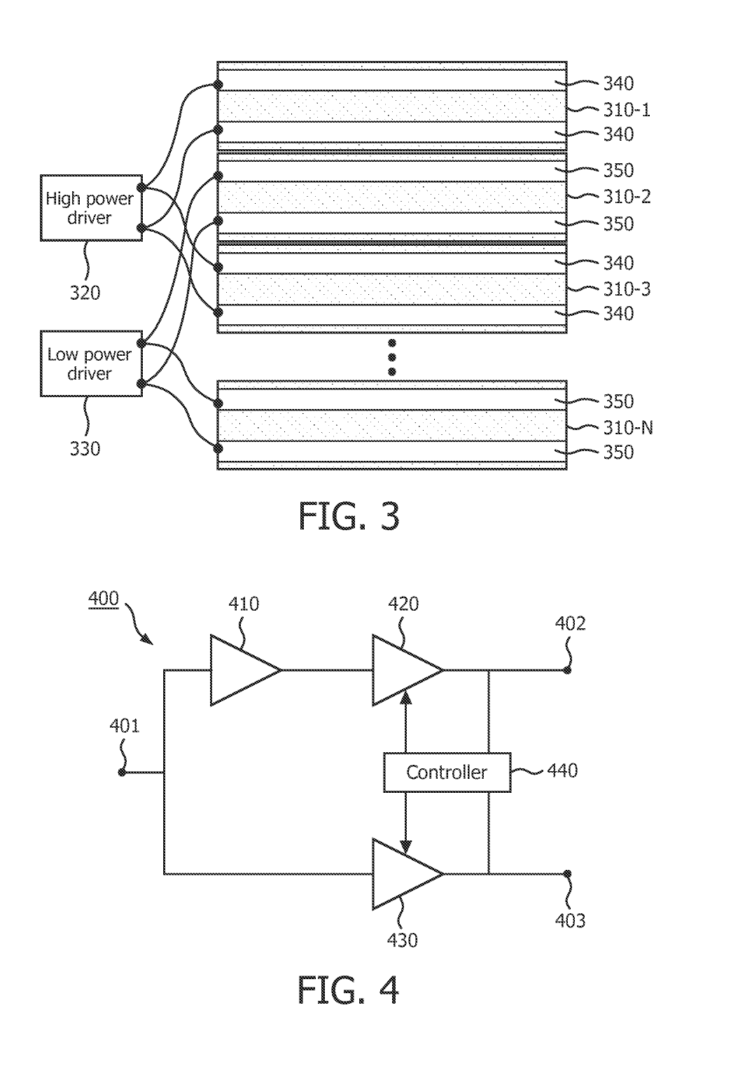

FIG. 3 is an illustration of an arrangement of power sub-areas in a capacitive powering system according to another embodiment of the invention.

FIG. 4 is a block diagram of a driver constructed to generate both low and high power AC signals.

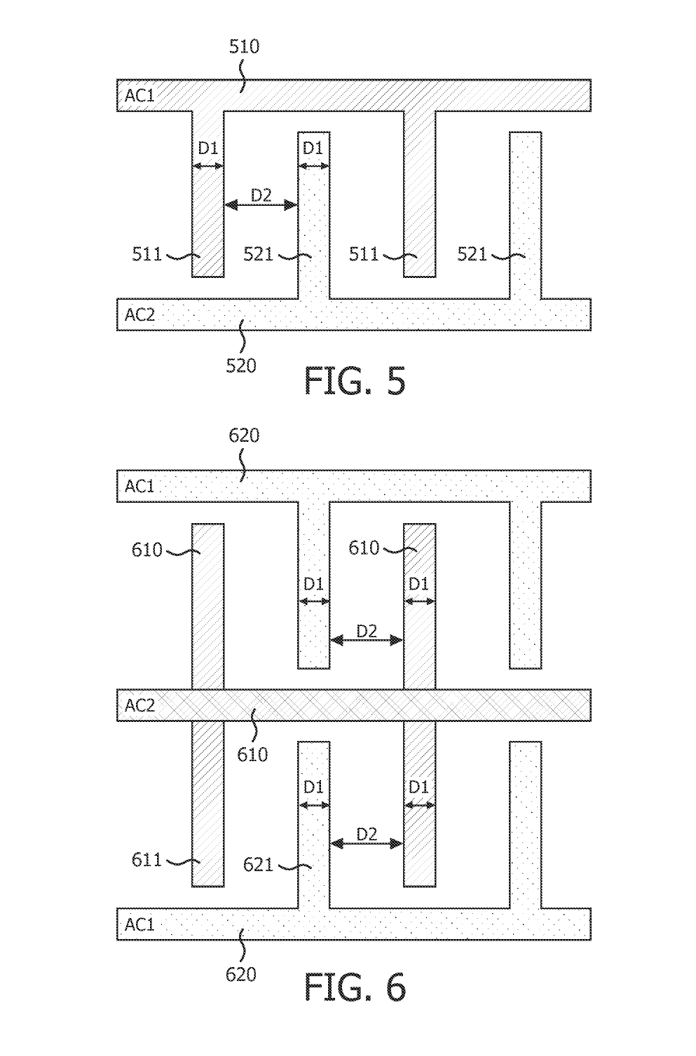

FIG. 5 is a diagram of transmitter electrodes constructed to allow freedom of placement in the horizontal direction according one embodiment.

FIG. 6 is a diagram of transmitter electrodes constructed to allow freedom of placement in the horizontal and vertical direction according to one embodiment.

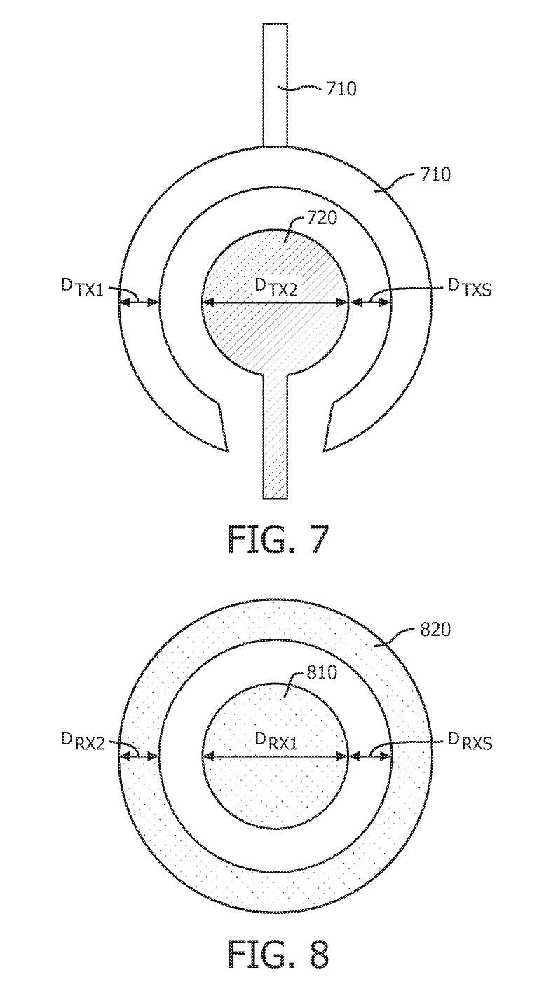

FIG. 7 is a diagram of circular transmitter electrodes constructed to allow 360 degrees of freedom of placement according to one embodiment.

FIG. 8 is a diagram of circular receiver electrodes constructed to allow 360 degrees of freedom of placement according to one embodiment.

It is important to note that the embodiments disclosed are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

FIG. 1 shows a schematic diagram of a capacitive powering system 100 utilized to describe various embodiments of the invention. The system 100 enables large area power transmissions and can be installed in places where open electrical contacts are not preferred or are not desirable, such as bathrooms, or retail-shops where regular lighting movement and variations are needed to illuminate a product, furniture, and the like. The system 100 can power devices mounted on walls, windows, mirrors, floors, seats, aisles, and so on.

The system 100 includes two drivers 111 and 112, each connected to a pair of transmitter electrodes. The driver 111 is connected to transmitter electrodes 121 and 122, while the driver 112 is connected to transmitter electrodes 123 and 124. It should be noted that the connection point of the electrode 124 with the driver 112 is merely for illustration purposes; the electrode 124 is parallel to the electrode 123.

All the transmitter electrodes 121, 122, 123, and 124 are attached to an insulating layer 130. The connection between the transmitter electrodes and their respective drivers may be by means of a galvanic contact or a capacitive in-coupling. The insulating layer 130 is a thin layer substrate material that can be of any insulating material, including for example, air, paper, wood, textile, glass, DI-water, and so on. In an embodiment, a material with dielectric permittivity is selected. The thickness of the insulating layer 130 is typically between 10 microns (e.g., a paint layer) and a few millimeters (e.g., a glass layer).

The system 100 also includes two loads 151 and 152, where the load 151 consumes more power than the load 152. That is, the load 151 is a high power load and the load 152 is a low power load. The load 151 is connected to a pair of receiver electrodes 141 and 142 as well as to an inductor 161. The load 152 is connected to a pair of receiver electrodes 143 and 144, and an inductor 162. Each of loads 151 and 152 may be, but is not limited to, lighting elements (e.g., LED, LED string, a lamp, etc.), displays, computers, power chargers, loudspeakers, and the like.

As the loads 151 and 152 are respectively high and low power loads, the system 100 is arranged to separate between high and low power transfers. That is, the system 100 consists of high and low power sub-areas, each supporting a different power level. The high power sub-area includes the transmitter electrodes 123 and 124, and the low power sub-area includes transmitter electrodes 121 and 122.

A power is supplied to the load 151 by placing the receiver electrodes 141, 142 in proximity to the transmitter electrodes 123 and 124 without having a direct contact between the two. Thus, no mechanical connector or any electrical contact is required in order to power the load 151. Similarly, the load 152 may be powered by an AC signal generated by the driver 111, by placing the receiver electrodes 143, 144 in proximity to the transmitter electrodes 121, 122.

Each of the drivers 111 and 112 outputs an AC signal having as a frequency the series-resonance frequency of a circuit consisting of a series of the capacitors and receptive inductors 161 or 162. The capacitors (C1 and C2) are the capacitive impedance of the transmitter electrodes and receiver electrodes connected to each of the loads. The impedances of the capacitors and inductor cancel each other out at the resonance frequency, resulting in a low-ohmic circuit.

It should be noted that the separation into high and low power sub-areas allows optimizing the performance of the capacitive wireless system, i.e., to power the loads 151 and 152 with very low power losses. Each of the drivers 111 and 112 can be independently adjusted to generate an AC signal that optimally powers its respective load. For example, if the load 151 is a 10 W lamp and the load 152 is a 0.1 W indicator LED, the driver 111 generates a 10 W AC signal and the driver 112 outputs a 0.1 W AC signal. Various embodiments for implementing the drivers 111, 112 are provided below.

In addition, the conductive material and the dimensions of the transmitter electrodes 121, 122 and 123, 124 can be independently selected to reduce the power losses. Thus, in the disclosed configuration, the high power load does not determine the power and electrodes' properties of the low power load.

Each pair of transmitter electrodes 121, 122 and 123, 124 is comprised of two separate bodies of conductive material, such as conductive stripes placed on one side of the insulating layer 130 that is not adjacent to the receiver electrodes. For example, as illustrated in FIG. 1, the transmitter electrodes 121 to 124 are at the bottom of the insulating layer 130. In another embodiment, the transmitter electrodes can be placed on opposite sides of the insulating layer 130. The transmitter electrodes may be placed vertically or horizontally on the insulating layer. The conductive material of each of the transmitter electrodes may be, for example, carbon, aluminum, indium tin oxide (ITO), organic material, such as PEDOT, copper, silver, conducting paint, or any conductive material. Each pair of receiver electrodes 141 to 144 can be of the same conductive material as the transmitter electrodes or made of different conductive material.

It should be noted that FIG. 1 illustrates a capacitive powering system 100 with two power sub-areas of low and high powers only for the sake of simplicity of the description. The capacitive wireless powering system 100 may include a plurality of power sub-areas powered by two or more drivers. Each power sub-area includes a pair of transmitter electrodes connected to a driver to transfer power to one or more loads connected to the receiver electrodes and an inductor as described above.

As shown in FIG. 2, the infrastructure of a capacitive powering system (e.g., system 100) can be separated into a plurality of power sub-areas 210-1 through 210-N (N is an integer number greater than 1). The power sub-areas 210-1 through 210-M (M is an integer number greater than 1) support high power loads (not shown), while the power sub-areas 210-M+1 through 210-N are for low power loads (not shown). In the arrangement shown in FIG. 2, the high power sub-areas 210-1 through 210-M are grouped together and low power sub-areas 210-M+1 to 210-N are grouped together separately from the high-power sub-areas.

The power sub-areas 210-1 to 210-M are connected to a driver 220 which generates a high power AC signal. The power sub-areas 210-M+1 to 210-N are connected to a low power driver 230 generating a low power AC signal. The amplitude, frequency, and waveform of the AC signals generated by each of the drivers 210 and 220 are determined based on the load or loads connected to the respective power sub-area. It should be noted that more than two drivers can drive the power sub-areas 210-1 to 210-N.

Each of the high power sub-areas 210-1 to 210-M includes a pair of transmitter electrodes, collectively labeled as 240. Similarly, each of the low power sub-areas 210-M+1 to 210-N includes a pair of transmitter electrodes, collectively labeled as 250. In one embodiment, the conductive material and/or the dimensions of the transmitter electrodes 240 are different than those of the transmitter electrodes 250. This is performed in order to optimize the power transfers to loads being wirelessly connected to the transmitter electrodes. As noted above, the properties of transmitter electrodes of high power sub-areas or low power sub-areas can be designed differently. That is, the conductive material of the transmitter electrodes of power sub-area 210-1 can be different from the transmitter electrodes in sub-area 210-M+1. In addition, the thicknesses and sizes of the transmitter electrodes and insulating layers in high and low power sub-areas can be different.

For example, copper can be used as the conductive material for the transmitter electrodes and plastic used as the insulting layer in the high power sub-area; as a result high currents can flow. On the other hand, ITO as a conductive material and glass as the insulting layer can be used in the low power area. Such an infrastructure has higher ohmic losses, but is a transparent surface.

In the embodiment shown in FIG. 2, the transmitter electrodes are illustrated as conductive stripes. However, as will be described below, the transmitter electrodes can alternatively be formed in various shapes and structures to allow continuous power transfer across the power sub-areas.

FIG. 3 shows another arrangement of the power sub-areas in a capacitive powering system (e.g., system 100) according to an embodiment of the invention. The system's infrastructure is separated into a plurality of power sub-areas 310-1 through 310-N (N is an integer number greater than 1). According to this embodiment, a high power sub-area is adjacent to a low power sub-area. For example, as illustrated in FIG. 3, a low power sub-area 310-2 is in between the high power sub-areas 310-1 and 310-3.

The high power sub-areas 310-1 and 310-3 are connected to a driver 320 which generates a high power AC signal. The low power sub-areas 310-2 and 310-N are connected to a low power driver 330 generating a low power AC signal. As mentioned above, the amplitude, frequency, and waveform of the AC signals generated by each of the drivers 310 and 320 are determined based on the load or loads connected to the respective power sub-area. It should be noted that more than two drivers can drive the power sub-areas 310-1 to 310-N.

Each of the high and low power sub-areas respectively includes a pair of transmitter electrodes, collectively labeled as 340 and 350. The conductive material and/or the dimensions of the transmitter electrodes 340 are different than those of the transmitter electrodes 350. As mentioned above, this is performed in order to optimize the power transfers to loads wirelessly connected to the transmitter electrodes. The properties of transmitter electrodes 340 of high power sub-areas or low power sub-areas (350) can be designed differently. The transmitter electrodes 340 and 350 can be formed in various shapes and structures to allow continuous power transfer across the power sub-areas.

In the arrangement shown in FIG. 3, power can be efficiently transferred to a load that consumes “medium power.” With this aim, one receiver electrode connected to the load overlaps one of the transmitter electrodes in a high power sub-area (e.g., sub-area 310-1), while the second receiver electrode overlaps a transmitter electrode in a low power sub-area (e.g., sub-area 310-2). Thus, the medium power load partially uses the high power area and partially uses the low power area, and the averaged consumed power is “medium.”

In the embodiments illustrated in FIGS. 2 and 3, a high power driver (220, 320) and a low power driver (230, 330) are used to generate and provide high and low power signals to high power sub-areas and low power sub-areas respectively. Typically, the high and low power signals are characterized by different amplitude and frequency to ensure series-resonance.

In an embodiment illustrated in FIG. 4, a driver 400 is constructed to generate and output both low and high power AC signals. A source signal 401, generated by an oscillator, generates an AC signal at the resonant frequency of the system and is input to two branches, high and low power, of the driver 400. In the high power branch, the signal is amplified by an amplifier 410 and input to an output amplifier 420. In the low power branch, the source signal 401 is directly input to an output amplifier 430. The output amplifiers 420 and 430 are utilized to tune the frequency, phase and/or the duty cycles of the high power signal 402 and low power signal 403, under the control of a controller 440. Any of the amplifiers 410, 420, and 430 may be any one of a linear amplifier, a resonant converter, and the like.

The controller 440, in one embodiment, senses the phase of the voltage and current at the outputs 402, 403 of the driver 400 to determine if tuning is required. Alternatively or collectively, the phase of the voltage and current are measured in the receiver electrodes. It should be noted that tuning of the high power signal 402 is performed in order to maximize the current flows through the loads connected in high power sub-areas and that the low power signal 403 is tuned to maximize current flows through the loads connected in low power sub-areas. As mentioned above, this is achieved when the series-resonance frequency of the system and the signal's frequency match.

FIG. 5 shows a non-limiting and exemplary diagram of transmitter electrodes 510 and 520 constructed in accordance with one embodiment. The transmitter electrodes 510 and 520 can be utilized in a large area capacitive wireless system (e.g., the system 100) to ensure continuous power transfer to the load, especially when the load is moved across the system infrastructure (e.g., insulating layer 130) in, for example, the horizontal direction. The transmitter electrodes 510 may further be configured such that that the power level transferred is not be degraded when the transmitter/receiver electrodes are located in a hot spot. That is, if the load connected to the receiver electrodes can be moved in the horizontal direction without power fluctuations.

The transmitter electrodes 510 and 520 have substantially the same width (D1) and each is designed as a comb-like pattern. The “fingers” (labeled as 511 and 521) of the transmitter electrodes 510 and 520 are alternatingly laid out within a distance (D2) from each other. The width (D1) of the transmitter electrodes 510 and 520 is smaller than the distance (D2). The transmitter electrodes 510 and 520 may be formed using any of the conductive materials mentioned above.

In a preferred embodiment, each of receiver electrode's conductive area has a width (D3) being larger than the distance (D2), but smaller than (D1+D2). This ensures continuous power transfer when the load is moved in the horizontal direction, as the receiver electrodes overlap the conductive areas of transmitter electrodes 510 and 520. The receiver electrodes may be structured as two conductive plates, each having a width (e.g., D3) and the distance between the two plates being significantly smaller than the width (D3). Thus, the two plates are placed in proximity to each other.

FIG. 6 shows a non-limiting and exemplary diagram of transmitter electrodes 610 and 620 constructed in accordance with one embodiment. The transmitter electrodes 610 and 620 can be utilized in a large area capacitive wireless system (e.g., the system 100) to ensure continuous power transfer to the load, especially when the load is moved across the system infrastructure (e.g., insulating layer 130) both in the horizontal and vertical directions. In the vertical direction, the transmitter electrodes 610 and 620 are rotated 180 degrees relative to the receiver electrodes.

The transmitter electrodes 610 and 620 have the same width (D1) and their “fingers” (labeled as 611 and 621) are alternatingly laid out within a distance (D2) from each other. The width (D1) of the transmitter electrodes 610 and 620 is smaller than the distance (D2). As illustrated in FIG. 6, in this embodiment, the transmitter electrode 620 includes two comb-like structures (upper and bottom) that are bound around the transmitter electrode 610. The transmitter electrodes 610 and 620 may be formed using any of the conductive materials mentioned above.

The receiver electrodes may be structured as two conductive plates, each having a width (e.g., D3) and the distance between the two plates being significantly smaller than the width (D3). It should be noted that with the transmitter electrodes 610 and 620 power is continuously transferred in both horizontal and vertical directions for the receiver electrodes. To this end, in a preferred embodiment, each of the receiver electrode's conductive area has a width (D3) being larger than the distance (D2), but smaller than (D1+D2). This ensures continuous power transfer when the load is moved in the horizontal direction, as the receiver electrodes overlap the conductive areas of transmitter electrodes 610 and 620.

In the vertical direction, a first receiver electrode of a pair of receiver electrodes overlaps the bottom transmitter electrode 620 while a second receiver electrode of the pair of receiver electrodes overlaps electrode 610. As the load is moved up in the vertical direction, the first receiver electrode overlaps the transmitter electrode 610 while a second receiver electrode overlaps the upper electrode 620.

FIG. 7 shows a non-limiting and exemplary diagram of transmitter electrodes 710 and 720 constructed in accordance with another embodiment. In this embodiment, the transmitter electrodes are circular, thus power can be continuously transferred at the same level when the receiver is turned left or right, but the transmitter stays at the same spot.

The transmitter electrode 710 is structured as an open-ring shape having a width (D_{TX1}). The transmitter electrode 720 is structured as a circle plate having a diameter (D_{TX2}). The transmitter electrode 720 is placed inside the electrode 710 within a distance (D_{TXS}) from each other. The layout of the electrodes 710 and 720 as shown in FIG. 7 is characterized by a lower electric field radiation encapsulated by the geometry of the structure shown in FIG. 7.

To enable a continuous power transfer, the receiver electrodes should also be circular, as illustrated in FIG. 8. A receiver electrode 810 is structured as a circular plate with a diameter D_{RX1} and a receiver electrode 820 is a ring having width D_{RX2}. The distance between the receiver electrodes 810 and 820 is D_{RXS}. The advantage of the structures shown in FIGS. 8 and 7 is that the load can be rotated without power fluctuations. The widths D_{RX1} and D_{RX2} of the receiver electrodes 810 and 820 should be made smaller than widths D_{TX2} and D_{TX1}, of the transmitter electrodes 710 and 720 respectively. And the distance D_{RXS} is smaller than distance D_{TXS}.

The principles of various embodiments of the invention can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analogy circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A capacitive powering system, comprising:
a low power driver;
a high power driver;
a plurality of pairs of transmitter electrodes separated into a plurality of power sub-areas, wherein the plurality of power sub-areas include at least a group of high power sub-areas connected to the high power driver and a group of low power sub-areas connected to the low power driver; and
an insulating layer having a first side and a second side opposite to each other, wherein the pairs of the plurality of transmitter electrodes are coupled to the first side of the insulating layer, wherein the system is configured to form a capacitive impedance between the pairs of the plurality of transmitter electrodes and a plurality of pairs of receiver electrodes placed in proximity to the second side of the insulating layer, each pair of receiver electrodes is connected in series to a load through an inductor to resonate at a different series-resonance frequency of the of the inductor and the capacitive impedance, thereby wirelessly transferring power from a pair of transmitter electrodes to a respective pair of receiver electrodes to power the load connected to the pair of receiver electrodes.

2. The system of claim 1, wherein a first group of a plurality of loads are high power loads and a second group of the plurality of loads are low power loads, wherein the system is configured for wirelessly coupling a pair of receiver electrodes to a low power load that overlaps a low power sub-area, thereby a low power signal generated by the low power driver is wirelessly transferred from a respective pair of transmitter electrodes to the pair of receiver electrodes to power a low power load, and
the system is further configured for wirelessly coupling a pair of receiver electrodes to a high power load that overlaps a high power sub-area, thereby a high power signal generated by the high power driver is wirelessly transferred from a respective pair of transmitter electrodes to the pair of receiver electrodes to power a high power load.

3. The system of claim 2, wherein a low power signal is wirelessly transferred to the low power load when a frequency of the low power signal matches a series-resonance frequency of an inductor connected to the low power load and the capacitive impedance;
and wherein a high power signal is wirelessly transferred to a high power load when a frequency of the high power signal matches a series-resonance frequency of an inductor connected to the high power load and the capacitive impedance.

4. The system of claim 1, wherein each of the high power sub-areas and each of the low power sub-areas includes a pair of transmitter electrodes.

5. The system of claim 1, wherein pairs of transmitter electrodes of the high power sub-areas and pairs of transmitter electrodes of the low power sub-areas are structured to have different properties to optimize the power transfer.

6. The system of claim 5, wherein the properties of the transmitter electrodes include at least one of: dimensions, structure, and conductive material.

7. The system of claim 5, wherein the high power sub-areas are grouped together and the low power sub-areas are grouped together.

8. The system of claim 5, wherein an arrangement of the power sub-areas includes a low power sub-area placed between two high power sub-areas.

9. The system of claim 8, wherein a pair of receiver electrodes is configured adjacent to the low power sub-area placed between two high power sub-areas and being wirelessly powered by the low power driver and the high power driver.

10. The system of claim 5, wherein a pair of transmitter electrodes of the plurality of pairs of transmitter electrodes are structured to allow continuous power transfer to a load when the load is moved in any one of a horizontal direction and a vertical direction.

11. The system of claim 10, wherein each of transmitter electrodes of the pair of transmitter electrodes is designed as a comb-like pattern having a first width, wherein the transmitter electrodes are alternatingly laid out within a fixed distance from each other, wherein the first width is smaller than the fixed distance.

12. The system of claim 10, wherein a first transmitter electrode of the pair of transmitter electrodes is placed within a second transmitter electrode of the pair of transmitter electrodes, wherein the second transmitter electrode includes an upper part and a bottom part, wherein the first transmitter electrode and the second transmitter electrode have a first width and are alternatingly laid out within a fixed distance from each other, wherein the first width is smaller than the fixed distance.

13. The system of claim 5, wherein transmitter electrodes of the pair of transmitter electrodes are circular, wherein a first transmitter electrode of a pair transmitter electrodes is structured as an open-ring shape having a first width and a second transmitter electrode of a pair transmitter electrodes is structured as a circle plate having a first diameter, wherein the second transmitter electrode is placed inside the first transmitter electrode within a first distance from each other.

14. The system of claim 13, wherein receiver electrodes of a pair of receiver electrodes are circular, wherein a first receiver electrode is structured as a circle plate having a second diameter and a second receiver electrode is structured as a ring shape having a second width, wherein the first receiver electrode is placed inside the second receiver electrode within a second fixed distance from each other.

15. The system of claim 14, wherein the second diameter is smaller than the first diameter, the second width is smaller than the first width, and the second distance is smaller than the first distance.
